(19) United States
(12) Patent Application Publication
(10) Pub. No.: US 2026/0197195 A1
(43) Pub. Date: Jul. 9, 2026

(54) VIDEO CONFERENCE RECORD GENERATION METHOD AND COMPUTER-READABLE RECORDING MEDIUM

(71) Applicant: ASUSTEK COMPUTER INC., TAIPEI (TW)

(72) Inventor: Jin-Xian WU, TAIPEI (TW)

(21) Appl. No.: 19/288,376

(22) Filed: Aug. 1, 2025

(30) Foreign Application Priority Data
Jan. 6, 2025 (TW) 114100465

(51) Int. Cl. H04L 12/18; G06F 21/32; G06V 40/16; G10L 15/26

(52) U.S. Cl. CPC H04L 12/1831; G06F 21/32; G06V 40/171; G06V 40/174; G10L 15/26; H04L 12/1822

(57) ABSTRACT

A video conference record generation method is provided, which is applicable to an electronic device. The electronic device is suitable for executing a video conference which allows a plurality of participants to join. First, a plurality of audio data clips generated during the video conference is obtained. Then, a participant corresponding to each of the audio data clips is determined. Then, a participant video data clip corresponding to each of the audio data clips is obtained and a plurality of emotion marks corresponding to the participant video data clips is generated according to the participant video data clips. Afterward, the audio data clips are integrated and converted into a conference text. Thereafter, the plurality of emotion marks is labelled at corresponding sections of the conference text to generate a conference record. The disclosure further provides a computer-readable recording medium containing a program.

### CROSS-REFERENCE TO RELATED APPLICATION

The disclosure claims the priority benefit of Taiwan application serial No. 114100465, filed on Jan. 6, 2025. The entirety of the above-mentioned patent application is hereby incorporated by reference herein and made a part of the specification.

### BACKGROUND OF THE INVENTION

### Field of the Invention

The disclosure relates to the field of video conference technologies, and particularly, to a video conference record generation method suitable for generating a conference record and a computer-readable recording medium.

### Description of the Related Art

A main disadvantage of an online conference is that limb interaction cannot be generated, difficulty in establishing a deep relationship with another participant, and difficulty in accurately determining a preference and a requirement of another participant (especially an important person). Consequently, an error may be caused, and communication efficiency and success rate are affected.

### BRIEF SUMMARY OF THE INVENTION

The disclosure provides a video conference record generation method applicable to an electronic device. The electronic device is suitable for executing a video conference which allows a plurality of participants to join. The video conference record generation method includes the following steps: obtaining a plurality of audio data clips generated during a video conference; determining a participant corresponding to each of the audio data clips; obtaining a participant video data clip corresponding to each of the audio data clips; integrating the audio data clips and converting the audio data clips into a conference text; generating a plurality of emotion marks corresponding to the participant video data clips according to the participant video data clips; and labeling the plurality of emotion marks at corresponding sections of the conference text to generate a conference record.

The disclosure further provides a computer-readable recording medium containing a program. When a computer loads the program and executes the program, the following steps are completed: obtaining a plurality of audio data clips generated during a video conference; determining a participant corresponding to each of the audio data clips; obtaining a participant video data clip corresponding to each of the audio data clips; integrating the audio data clips and converting the audio data clips into a conference text; generating a plurality of emotion marks corresponding to the participant video data clips according to the participant video data clips; and labeling the plurality of emotion marks at corresponding sections of the conference text to generate a conference record.

According to the video conference record generation method provided in the disclosure, emotion marks corresponding to a text data clip of each participant are generated, and the conference text data and the emotion marks are combined into a conference record. Therefore, a user can accurately determine a preference and a requirement of another participant, thereby avoiding occurrence of an error from affecting communication efficiency and success rate.

### BRIEF DESCRIPTION OF THE DRAWINGS

FIG. 1 is a schematic diagram of a video conference record generation apparatus according to an embodiment of the disclosure;

FIG. 2 is a flowchart of a video conference record generation method according to a first embodiment of the disclosure;

FIG. 3 illustrates an embodiment of step S220 in FIG. 2;

FIG. 4 illustrates another embodiment of step S220 in FIG. 2;

FIG. 5 illustrates an embodiment of step S240 in FIG. 2;

FIG. 6 is a flowchart of a video conference record generation method according to a second embodiment of the disclosure;

FIG. 7 is a flowchart of a video conference record generation method according to a third embodiment of the disclosure; and

FIG. 8 is a flowchart of a video conference record generation method according to a fourth embodiment of the disclosure.

### DETAILED DESCRIPTION OF THE EMBODIMENTS

More detailed descriptions of specific embodiments of the disclosure are provided below with reference to the schematic diagrams. The features and advantages of the disclosure are described more clearly according to the following descriptions and claims. It should be noted that all of the drawings use very simplified forms and imprecise proportions, only being used for assisting in conveniently and clearly explaining the objective of the embodiments of the disclosure.

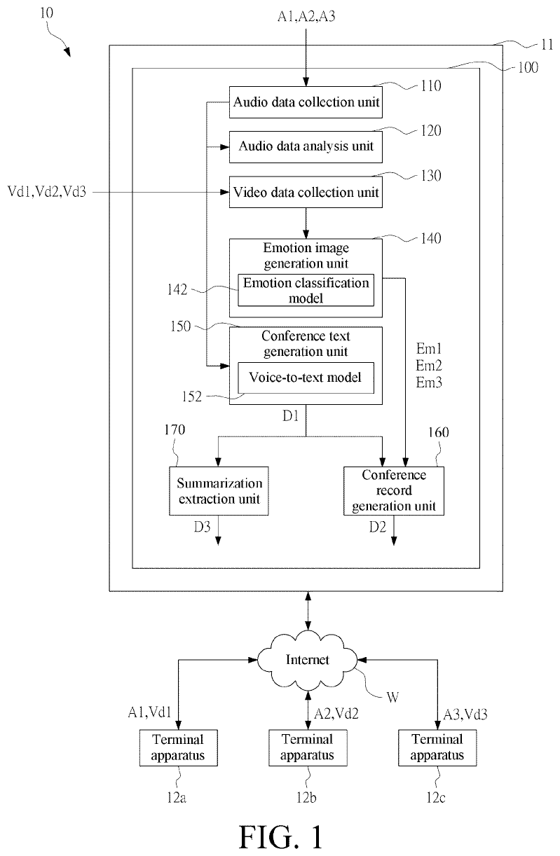

FIG. 1 is a schematic diagram of a video conference record generation apparatus 100 according to an embodiment of the disclosure. The video conference record generation apparatus 100 is applicable to a video conference system 10. The video conference system 10 includes a server 11 and a plurality of terminal apparatuses 12a, 12b, and 12c (only three terminal apparatuses 12a, 12b, and 12c are shown in the figure for illustration). The terminal apparatuses 12a, 12b, and 12c are connected to the server 11 through the Internet W, and participants are connected to the server 11 through the terminal apparatuses 12a, 12b, and 12c to participate in a video conference.

The video conference record generation apparatus 100 is disposed in the server 11. The video conference record generation apparatus includes an audio data collection unit 110, an audio data analysis unit 120, a video data collection unit 130, an emotion image generation unit 140, a conference text generation unit 150, and a conference record generation unit 160.

The audio data collection unit 110 is configured to obtain a plurality of audio data clips A1, A2, and A3 generated during a video conference. In an embodiment, the audio data collection unit 110 obtains the audio data clips A1, A2, and A3 from audio data sources (that is, the terminal apparatuses 12a, 12b, and 12c) according to a chronological order of the conference. In the embodiment shown in FIG. 1, the terminal apparatuses 12a, 12b, and 12c generate the audio data clips A1, A2, and A3 (that is, participants corresponding to the terminal apparatuses 12a, 12b, and 12c all speak). However, the disclosure is not limited thereto. In an actual use scenario, some of the terminal apparatuses 12a, 12b, and 12c do not generate the audio data clips A1, A2, and A3.

The audio data analysis unit 120 is configured to determine the participants corresponding to the audio data clips A1, A2, and A3. In an embodiment, the audio data analysis unit 120 determines, according to the data sources, the participants corresponding to the audio data clips A1, A2, and A3. Specifically, audio data clips A1, A2, and A3 from a same terminal apparatus 12a, 12b, or 12c are considered as belonging to the same participant.

The video data collection unit 130 is configured to obtain participant video data clips Vd1, Vd2, and Vd3 corresponding to the audio data clips A1, A2, and A3. In an embodiment, first, the video data collection unit 130 records a video of the video conference during the video conference, and obtain, according to the participants and time periods corresponding to the audio data clips A1, A2, and A3, the participant video data clips Vd1, Vd2, and Vd3 corresponding to the audio data clips A1, A2, and A3.

The emotion image generation unit 140 is configured to generate, according to the participant video data clips Vd1, Vd2, and Vd3, a plurality of emotion marks Em1, Em2, and Em3 corresponding to the participant video data clips Vd1, Vd2, and Vd3. In an embodiment, the emotion mark Em1, Em2, or Em3 is an emoji. However, the disclosure is not limited thereto.

In an embodiment, the emotion image generation unit 140 includes an emotion classification model 142 configured to analyze a facial feature of each participant to output emotion classification data (such as anger, happiness, or the like). The emotion classification model 142 is a trained deep-learning classification model.

The conference text generation unit 150 is configured to integrate the audio data clips A1, A2, and A3, and convert the audio data clips A1, A2, and A3 into a conference text D1. In an embodiment, the conference text generation unit 150 includes a voice-to-text model 152. The conference text generation unit 150 integrates, according to a chronological order, the plurality of audio data clips A1, A2, and A3 generated during the video conference into a single audio record, and converts the audio record into the conference text D1.

The conference record generation unit 160 is configured to label the plurality of emotion marks Em1, Em2, and Em3 at corresponding sections of the conference text D1, to generate a conference record D2.

In an embodiment, the video conference record generation apparatus 100 further includes a summarization extraction unit 170. The summarization extraction unit 170 is electrically coupled to the conference text generation unit 150 and is configured to extract a summarization from the conference text D1, to generate a summarization text D3. The summarization extraction unit 170 analyzes the conference text D1 in an extractive summarization generation manner or an abstractive summarization generation manner, to generate the summarization text D3.

In this embodiment, the video conference record generation apparatus 100 is disposed in the server 11 to generate the conference record D2. However, the disclosure is not limited thereto. In another embodiment, the video conference record generation apparatus 100 is alternatively disposed in the terminal apparatus 12a, 12b, or 12c. Further, in an embodiment, the video conference record generation apparatus 100 is a software program stored in a non-transitory computer-readable recording medium.

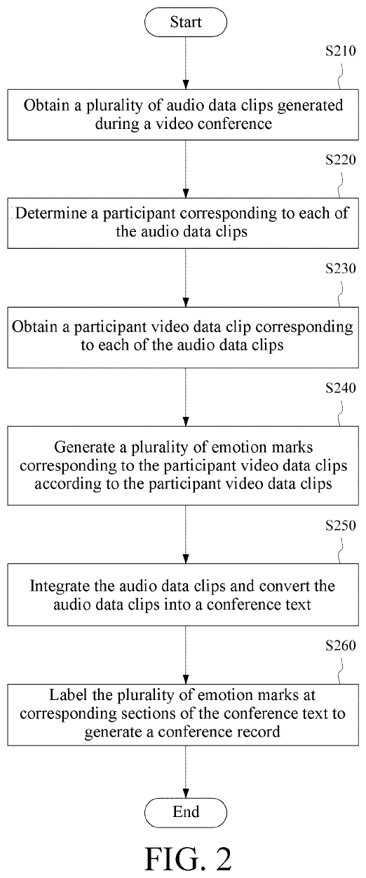

Referring to FIG. 2, FIG. 2 is a flowchart of a video conference record generation method according to a first embodiment of the disclosure. The video conference record generation method is applicable to an electronic device, and the electronic device is suitable for executing a video conference. The video conference allows a plurality of participants to join. The electronic device is the server 11 shown in FIG. 1, or the terminal apparatus 12a, 12b, or 12c shown in FIG. 1.

As shown in the figure, the video conference record generation method includes the following steps.

First, as described in step S210, a plurality of audio data clips A1, A2, and A3 generated during the video conference is obtained. In an embodiment, in this step, the audio data clips A1, A2, and A3 are obtained from audio data sources according to a chronological order of the conference.

Then, as described in step S220, a participant corresponding to each of the audio data clips A1, A2, and A3 is determined.

Then, as described in step S230, a participant video data clip Vd1, Vd2, or Vd3 corresponding to each of the audio data clips A1, A2, and A3 is obtained.

Afterward, as described in step S240, according to the participant video clips Vd1, Vd2, and Vd3, a plurality of emotion marks Em1, Em2, and Em3 corresponding to the participant video data clips Vd1, Vd2, and Vd3 is respectively generated. In an embodiment, the emotion mark Em1, Em2, or Em3 is an emoji. In an embodiment, the emotion marks Em1, Em2, and Em3 respectively correspond to different emotion color markings.

Afterward, as described in step S250, the audio data clips A1, A2, and A3 are integrated and are converted into a conference text D1. In an embodiment, in this step, according to a chronological order, the plurality of audio data clips A1, A2, and A3 generated during the video conference is integrated into a single audio record, and the single audio record is converted into the conference text D1 through a voice-to-text model.

Thereafter, as described in step S260, the plurality of emotion marks Em1, Em2, and Em3 is labelled at corresponding sections of the conference text D1 to generate a conference record D2.

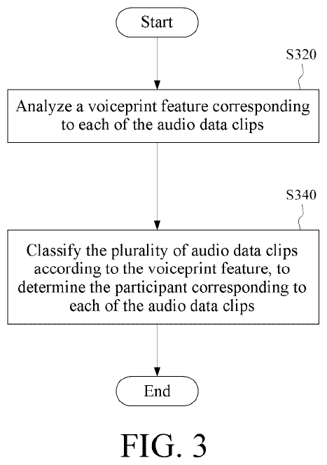

Referring to FIG. 3, FIG. 3 shows an embodiment of step S220 in FIG. 2.

First, as described in step S320, a voiceprint feature corresponding to each of the audio data clips A1, A2, and A3 is analyzed.

Then, as described in step S340, the plurality of audio data clips A1, A2, and A3 is classified according to the voiceprint feature, to determine the participant corresponding to each of the audio data clips A1, A2, and A3.

In an embodiment, in the foregoing step S320, a parameter (that is, the voiceprint feature) such as a speech speed, an intonation, or sound quality of each of the audio data clips A1, A2, and A3 is analyzed, to determine the voiceprint feature corresponding to each of the audio data clips A1, A2, and A3. Afterward, through voiceprint comparison, whether the audio data clips A1, A2, and A3 belong to the same participant is identified. Basically, different participants in the video conference are distinguished by comparing differences between the voiceprint data.

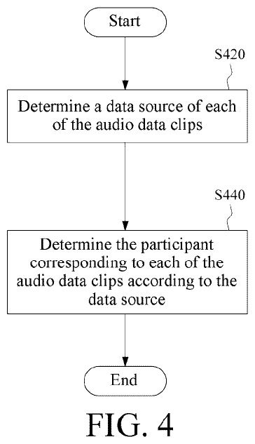

Referring to FIG. 4, FIG. 4 shows another embodiment of step S220 in FIG. 2.

First, as described in step S420, a data source of each of the audio data clips A1, A2, and A3 is determined. In step S420, it is determined, in the video conference, which terminal apparatus 12a, 12b, or 12c (a participant) the audio data comes from.

Then, as described in step S440, the participant corresponding to each of the audio data clips A1, A2, and A3 is determined based on the data source. Specifically, the audio data clips A1, A2, and A3 from the same audio data source (that is, the terminal apparatus 12a, 12b, or 12c, or the participant) are considered as belonging to the same participant.

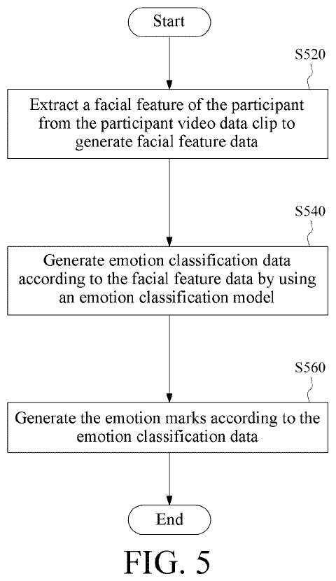

Referring to FIG. 5, FIG. 5 shows an embodiment of step S240 in FIG. 2.

First, as described in step S520, a facial feature of the participant is extracted from the participant video data clip to generate facial feature data.

Then, as described in step S540, by using an emotion classification model, emotion classification data is generated based on the facial feature data. In an embodiment, the emotion classification model is a trained deep-learning classification model.

Afterward, as described in step S560, emotion marks Em1, Em2, and Em3 are generated based on the emotion classification data.

In an embodiment, to shorten an operation time, the foregoing emotion classification model has a plurality of preset emotion types. In step S540, the facial feature data is classified according to the preset emotion types to generate the emotion classification data (that is, a preset emotion type to which the data belongs). Each of the preset emotion types is preset with the corresponding emotion mark Em1, Em2, or Em3. In step S560, the corresponding emotion mark Em1, Em2, or Em3 is directly output based on the emotion classification data.

Further, in another embodiment, the emotion classification model 142 is provided with the plurality of preset emotion types. In step S540, the facial feature data is classified according to the preset emotion types to generate the emotion classification data (that is, a preset emotion type to which the data belongs). In addition, each of the preset emotion types is preset with a corresponding emotion color marking. The emotion color marking is used for labeling or presenting a corresponding text in the conference text D1.

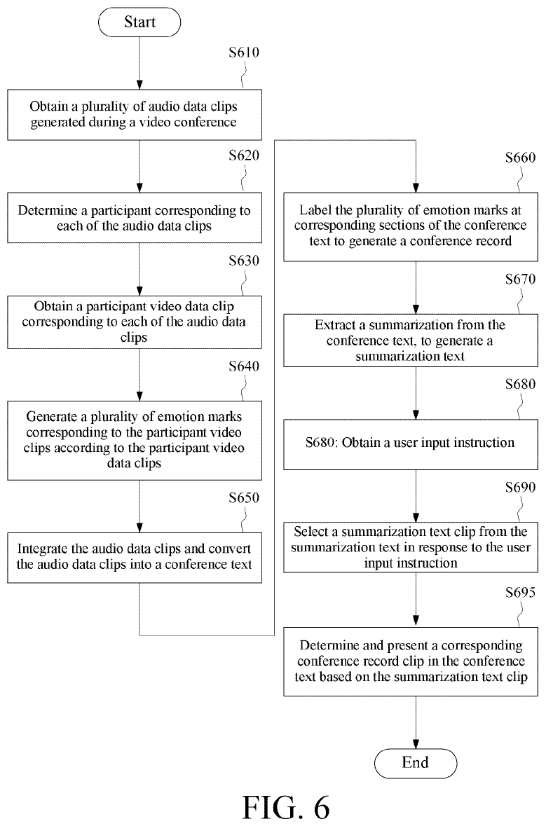

Referring to FIG. 6, FIG. 6 is a flowchart of a video conference record generation method according to a second embodiment of the disclosure. As shown in the figure, the video conference record generation method includes the following steps.

First, as described in step S610, a plurality of audio data clips A1, A2, and A3 generated during a video conference is obtained.

Then, as described in step S620, a participant corresponding to each of the audio data clips A1, A2, and A3 is determined.

Then, as described in step S630, a participant video data clip Vd1, Vd2, or Vd3 corresponding to each of the audio data clips A1, A2, and A3 is obtained.

Afterward, as described in step S640, according to the participant video clips Vd1, Vd2, and Vd3, a plurality of emotion marks Em1, Em2, and Em3 corresponding to the participant video data clips Vd1, Vd2, and Vd3 is respectively generated.

Afterward, as described in step S650, the audio data clips A1, A2, and A3 are integrated and are converted into a conference text D1.

Thereafter, as described in step S660, the plurality of emotion marks Em1, Em2, and Em3 is labelled at corresponding sections of the conference text D1 to generate a conference record D2.

Step S610 to step S660 are similar to step S210 to step S260 in FIG. 2. Details are not described herein.

Then, as described in step S670, a summarization is extracted from the conference text D1, to generate a summarization text D3. In step S670, the conference text D1 is analyzed in an extractive summarization generation manner or an abstractive summarization generation manner, to generate the summarization text D3.

Then, as described in step S680, a user input instruction is obtained.

Afterward, as described in step S690, a summarization text clip is selected from the summarization text D3 in response to the user input instruction.

Thereafter, as described in step S695, a corresponding conference record clip in the conference record D2 is determined and presented based on the summarization text clip.

In an embodiment, in step S670, text source data in the summarization text D3 is reserved in a process of extracting the summarization from the conference text D1. Subsequently, in step S695, the corresponding conference record clip in the conference record D2 is determined based on the text source data.

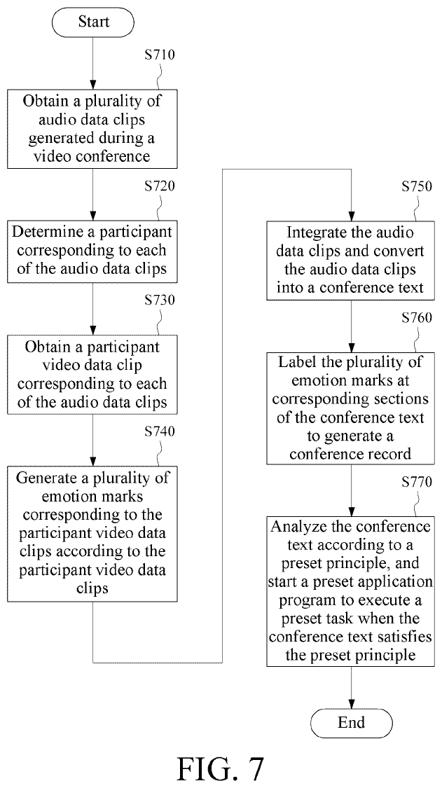

Referring to FIG. 7, FIG. 7 is a flowchart of a video conference record generation method according to a third embodiment of the disclosure. As shown in the figure, the video conference record generation method includes the following steps.

First, as described in step S710, a plurality of audio data clips A1, A2, and A3 generated during a video conference is obtained.

Then, as described in step S720, a participant corresponding to each of the audio data clips A1, A2, and A3 is determined.

Then, as described in step S730, a participant video data clip Vd1, Vd2, or Vd3 corresponding to each of the audio data clips A1, A2, and A3 is obtained.

Afterward, as described in step S740, according to the participant video clips Vd1, Vd2, and Vd3, a plurality of emotion marks Em1, Em2, and Em3 corresponding to the participant video data clips Vd1, Vd2, and Vd3 is respectively generated.

Afterward, as described in step S750, the audio data clips A1, A2, and A3 are integrated and are converted into a conference text D1.

Thereafter, as described in step S760, the plurality of emotion marks Em1, Em2, and Em3 is labelled at corresponding sections of the conference text D1 to generate a conference record D2.

Step S710 to step S760 are similar to step S210 to step S260 in FIG. 2. Details are not described herein.

Compared with the embodiment in FIG. 2, in this embodiment, after the conference record D2 is generated, step S770 is further included: analyzing the conference text D1 according to a preset principle, and when the conference text D1 satisfies the preset principle, starting a default application program to execute a default task.

In an embodiment, the preset principle is a description text of a location, time, or a commodity that exists in the conference text D1. The default application program is a map application program, a calendar application program, or a picture browsing application program. In an embodiment, when the description text of the location exists in the conference text D1, the map application program is started, and the location described in the conference text is labelled on the map application program (a default task). When the description text of the commodity exists in the conference text D1, the picture browsing application program is started, and a corresponding commodity picture is started.

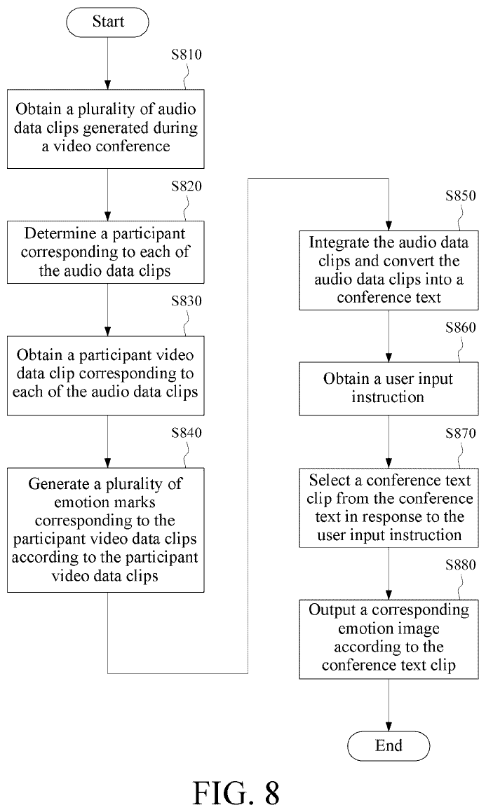

Referring to FIG. 8, FIG. 8 is a flowchart of a video conference record generation method according to a fourth embodiment of the disclosure.

First, as described in step S810, a plurality of audio data clips A1, A2, and A3 generated during a video conference is obtained.

Then, as described in step S820, a participant corresponding to each of the audio data clips A1, A2, and A3 is determined.

Then, as described in step S830, a participant video data clip Vd1, Vd2, or Vd3 corresponding to each of the audio data clips A1, A2, and A3 is obtained.

Afterward, as described in step S840, according to the participant video clips Vd1, Vd2, and Vd3, a plurality of emotion marks Em1, Em2, and Em3 corresponding to the participant video data clips Vd1, Vd2, and Vd3 is respectively generated.

Afterward, as described in step S850, the audio data clips A1, A2, and A3 are integrated and are converted into a conference text D1.

Step S810 to step S850 are similar to step S210 to step S250 in FIG. 2. Details are not described herein.

Then, as described in step S860, a user input instruction is obtained.

Afterward, as described in step S870, a conference text clip is selected from the conference text D1 in response to the user input instruction.

Then, as described in step S880, a corresponding emotion image is output according to the conference text clip.

In an embodiment, in step S880, the audio data clip A1, A2, or A3 corresponding to the conference text clip is determined first, and then, a corresponding emotion image (that is, the emotion mark Em1, Em2, or Em3) is output. However, the disclosure is not limited thereto. In another embodiment, a corresponding image is generated according to the conference text clip as the emotion image by using a text-to-image generation model.

The disclosure further provides a non-transitory computer-readable recording medium containing a program, which is suitable for a video conference to generate a video conference record. When a computer loads the program and executes the program, the following actions are completed. First, a plurality of audio data clips A1, A2, and A3 generated during the video conference is obtained. Then, a participant corresponding to each of the audio data clips A1, A2, and A3 is determined. Then, a participant video data clip Vd1, Vd2, or Vd3 corresponding to each of the audio data clips A1, A2, and A3 is obtained. Afterward, according to the participant video data clips Vd1, Vd2, and Vd3, a plurality of emotion marks Em1, Em2, and Em3 corresponding to the participant video data clips Vd1, Vd2, and Vd3 is respectively generated. Afterward, the audio data clips A1, A2, and A3 are integrated and are converted into a conference text D1. Thereafter, the plurality of emotion marks Em1, Em2, and Em3 is labelled at corresponding sections of the conference text D1 to generate a conference record D2.

According to the video conference record generation method provided in the disclosure, the emotion marks Em1, Em2, and Em3 corresponding to the text clips of the participants are generated, and further data of the conference text D1 and the emotion marks Em1, Em2, and Em3 are combined into the conference record D2. Therefore, a user can accurately determine a preference and a requirement of another participant (especially an important person), thereby avoiding occurrence of an error from affecting communication efficiency and success rate.

The above is merely exemplary embodiments of the disclosure, and does not constitute any limitation on the disclosure. Any form of equivalent replacements or modifications to the technical means and technical content disclosed in the disclosure made by a person skilled in the art without departing from the scope of the technical means of the disclosure still fall within the content of the technical means of the disclosure and the protection scope of the disclosure.

What is claimed is:

1. A video conference record generation method, applicable to an electronic device, wherein the electronic device is suitable for executing a video conference, the video conference allows a plurality of participants to join, and the video conference record generation method comprises:
obtaining a plurality of audio data clips generated during the video conference;
determining the participant corresponding to each of the audio data clips;
obtaining a participant video data clip corresponding to each of the audio data clips;
generating a plurality of emotion marks corresponding to the participant video data clips according to the participant video data clips;
integrating the audio data clips and converting the audio data clips into a conference text; and
labeling the plurality of emotion marks at corresponding sections of the conference text to generate a conference record.

2. The video conference record generation method according to claim 1, wherein the step of determining the participant corresponding to each of the audio data clips comprises:
analyzing a voiceprint feature corresponding to each of the audio data clips; and
classifying the plurality of audio data clips according to the voiceprint feature, to determine the participant corresponding to each of the audio data clips.

3. The video conference record generation method according to claim 1, wherein the step of determining the participant corresponding to each of the audio data clips comprises:
determining a data source of each of the audio data clips; and
determining the participant corresponding to the audio data clips according to the data source.

4. The video conference record generation method according to claim 1, wherein the emotion mark is an emoji.

5. The video conference record generation method according to claim 1, further comprising:
generating a plurality of emotion color markings corresponding to the audio data clips according to the participant video data clips; and
labeling a text in the conference text with the corresponding emotion color marking.

6. The video conference record generation method according to claim 1, further comprising:
extracting a summarization from the conference text, to generate a summarization text.

7. The video conference record generation method according to claim 1, further comprising:
analyzing the conference text according to a preset principle, and starting a default application program when the conference text satisfies the preset principle.

8. The video conference record generation method according to claim 7, wherein the default application program is a map application program.

9. The video conference record generation method according to claim 7, wherein the default application program is a calendar application program.

10. The video conference record generation method according to claim 7, wherein the default application program is a picture browsing application program.

11. The video conference record generation method according to claim 1, further comprising:
obtaining a user input instruction;
selecting a conference text clip from the conference text in response to the user input instruction; and
generating an image according to the conference text clip by using a text-to-image generation model.

12. The video conference record generation method according to claim 1, wherein the step of generating a plurality of emotion marks corresponding to the participant video data clips according to the participant video data clips comprises:
extracting a facial feature of the participant from the participant video clip to generate facial feature data;
generating emotion classification data according to the facial feature data by using an emotion classification model; and
generating the emotion marks according to the emotion classification data.

13. A non-transitory computer-readable recording medium containing a program, wherein when a computer loads and executes the program, the video conference record generation method according to claim 1 is performed.
